(19) United States
(12) Patent Application Publication
(10) Pub. No.: US 2006/0254329 A1
(43) Pub. Date: Nov. 16, 2006

(54) Dual locking device

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/401,233

(22) Filed: Apr. 11, 2006

Related U.S. Application Data
(63) Continuation-in-part of application No. 11/126,199, filed on May 11, 2005, now Pat. No. 7,104,092.

(51) Int. Cl. E05B 37/00

(52) U.S. Cl. 70/284

(57) ABSTRACT

A dual locking device is provided for securing a plugging member of a case, such as a luggage case or suitcase or the like, and comprises a housing, a switching mechanism, a restriction member and two locking devices. The switching mechanism includes a push-button and a securing member movable relative to the housing between a locked position and an unlocked position. Additionally, the restriction member is controlled by the locking devices respectively for retaining the switching mechanism, and is movable either through a first route between a retaining position and a first releasing position or through a second route between the retaining position and a second releasing position.

### CROSS REFERENCE TO RELATED APPLICATION

This is a continuation-in-part application of the co-pending U.S. Ser. No. 11/126,199 application, filed on May 11, 2005.

### TECHNICAL FIELD

This invention relates generally to a dual locking device for securing a plugging member, such as a zipper, of a luggage case. More particularly, to a dual locking device has an indicator.

### BACKGROUND OF THE INVENTION

Various mechanical structures are employed to fabricate a lock device, especially in the design of a complicated dual locking device for security to against terrorists. One conventional technique, relative to the dual locking device, is disclosed in U.S. Pat. No. 6,843,080. The dual locking device of U.S. Pat. No. 6,843,080 has a shifting member controlled by a combination lock to block or open a bendable shackle element from a corresponding locking hole. Under the control of the combination lock, the shifting member itself is both linear displaceable and deflectedable about a horizontal shaft. When a correct code of the combination lock is set, a stopper of the shackle element can be brought to push the shifting member so that the shifting member is forced to deflect and displace to come off the corresponding locking hole so as to release the shackle element from the locking hole.

One limitation of U.S. Pat. No. 6,843,080 for the dual locking device is the difficulty or impossibility of applying the shifting member with two motions on a zipper lock for securing a latch hole of a zipper.

Another conventional lock is disclosed in U.S. Pat. No. 6,912,880 and is also relative to the dual locking device, which has a stopping member to block or open a way of a push-button to constrain or release a lock tongue of the dual locking device. More specifically, the stopping member is pivotally mounted in a lock body under controls of a key lock and a combination lock. Moreover, the key lock is far from the stopping member and is linked via a linking member. Upon this complicated design, the conventional lock of the U.S. Pat. No. 6,912,880 is big in size for its complicated structure with extra elements, such as the linking member and two push-buttons.

For microminiaturization of the lock, it would be advantage to provide a dual locking device, which is capable of meeting the increasingly insistent requests for reduction in cost, weight, section, and dimensions with the same reliability and usability.

From the foregoing descriptions, it will be seen that room exists for improvements in the base.

### SUMMARY OF INVENTION

These needs have been partially resolved through the introduction of the present invention, whose characteristics include the reduction of dimension and weight, an easier assembly process, an increase in performance and a general reduction in production costs.

To overcome this, one aspect of the present invention proposes a miniature dual locking device to securing a plugging member, such as two pull tabs of a zipper fastener or two hook members on a luggage case. The design of the plugging member will make sure to be concise without losing the benefits of the prior art.

Accordingly, the present invention, briefly summarized, discloses a dual locking device comprising a housing, having at least one opening communicating with the interior of the housing for receiving a plugging member; a switching mechanism, having a push-button and a securing member movable relative to the housing between a locked position and an unlocked position by pushing the push-button which drives the securing member and is partly exposed the outside of the housing; a restriction member capable of moving through a first route between a retaining position to a first releasing position and through a second route between the retaining position to a second releasing position; wherein the restriction member limits the movement of the switching mechanism while in the retaining position, and permits the switching mechanism to move to the unlocked position while in the first or second releasing positions; a first locking device provided for controlling the movement of the restriction member via the first route; and a second locking device provided for controlling the movement of the restriction member via the second route.

Additionally, the dual locking device of the present invention can further comprise an indicator, which normally displays a first state, but displays a second state when the dual locking device is unlocked by utilizing the first locking device. With the different states of the indicator, a lock owner who usually uses the second locking device can identify whether the dual locking device has been unlocked by anyone who uses the first locking device.

Another aspect of the present invention discloses a case comprising a case body, a case cover and the dual locking device as mentioned above, wherein a side of the case body is jointed with a side of the case cover, and the plugging member is mounted on the case cover for being secured in the dual locking device which is mounted on the case body.

### BRIEF DESCRIPTION OF DRAWINGS

The invention will now be described solely by way of example and with reference to the accompanying drawings in which:

FIG. 1 is an exploded perspective view of a dual locking device in accordance with a first embodiment of the present invention;

FIG. 2 is a perspective assembly view of FIG. 1;

FIG. 3 shows that a restricting member is located between a combination lock and a push button according to the first embodiment;

FIG. 4 is a side view of FIG. 3;

FIG. 5 shows that the dual locking device is unlocked via the combination lock according to the first embodiment;

FIG. 6 is a side view of FIG. 5;

FIG. 7 shows that the dual locking device is unlocked via a key lock according to the first embodiment;

FIG. 8 is a regionally enlarged perspective view of FIG. 7;

FIG. 9 shows a room being formed by turning the restricting member;

FIG. 10 is a regionally enlarged perspective view of FIG. 9;

FIG. 11 is an opposite view of FIG. 10;

FIG. 12 shows a reposition device being used to restore an indicator according to the first embodiment;

FIG. 13 is a regionally enlarged perspective view of FIG. 12;

FIG. 14 is an opposite view of FIG. 13;

FIG. 15 is an exploded perspective view of a dual locking device in accordance with a second embodiment of the present invention;

FIG. 16 is a perspective assembly view of FIG. 15;

FIG. 17 shows that a restricting member is blocked between a combination lock and a push button according to the second embodiment;

FIG. 18 shows that the dual locking device is unlocked via the combination lock according to the second embodiment;

FIG. 19 shows that the dual locking device is unlocked via a key lock according to the second embodiment;

FIG. 20 shows that a push-button is used to restore an indicator according to the second embodiment;

FIG. 21 is a perspective view of a dual locking device in accordance with a third embodiment of the present invention;

FIG. 22 shows that a restricting member is blocked between a combination lock and a push-button according to the third embodiment;

FIG. 23 is a side view of the FIG. 22;

FIG. 24 shows that the dual locking device is unlocked via the combination lock according to the third embodiment;

FIG. 25 is a side view of the FIG. 24;

FIG. 26 shows that the dual locking device is unlocked via a key lock according to the third embodiment;

FIG. 27 is a side view of the FIG. 26; and

FIG. 28 is a perspective view of a case in accordance with another aspect of the present invention.

### DETAILED DESCRIPTION OF PREFERRED EMBODIMENTS

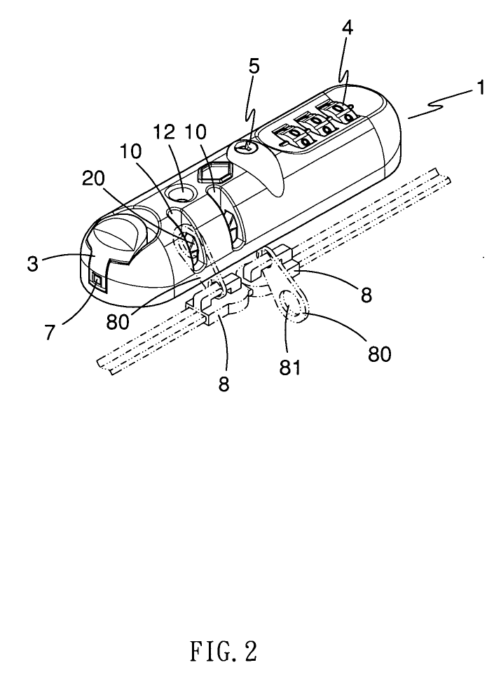

The present invention is mainly provided with a dual locking device for securing a plugging member, such as a pull tab of a luggage case, as shown in FIG. 2.

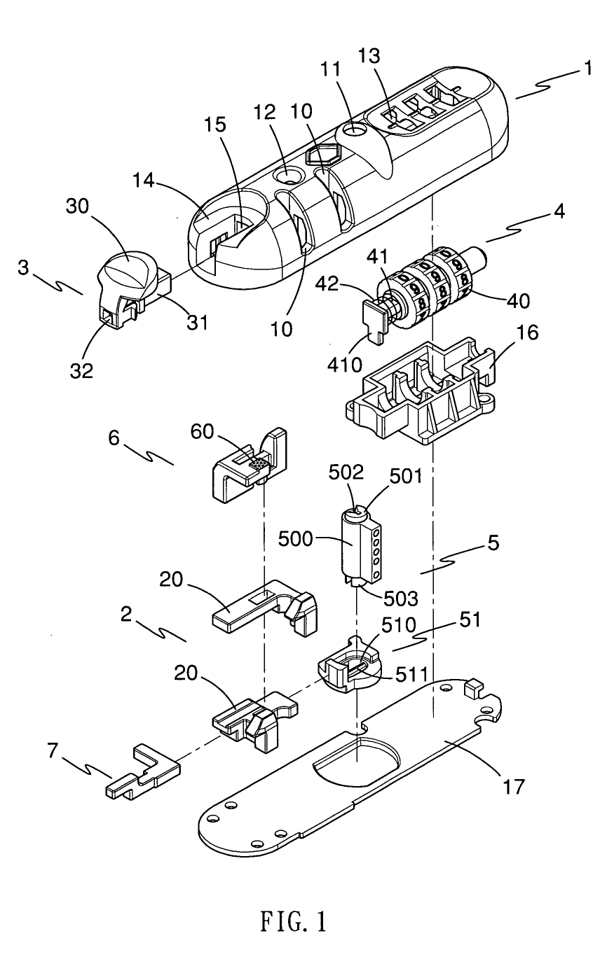

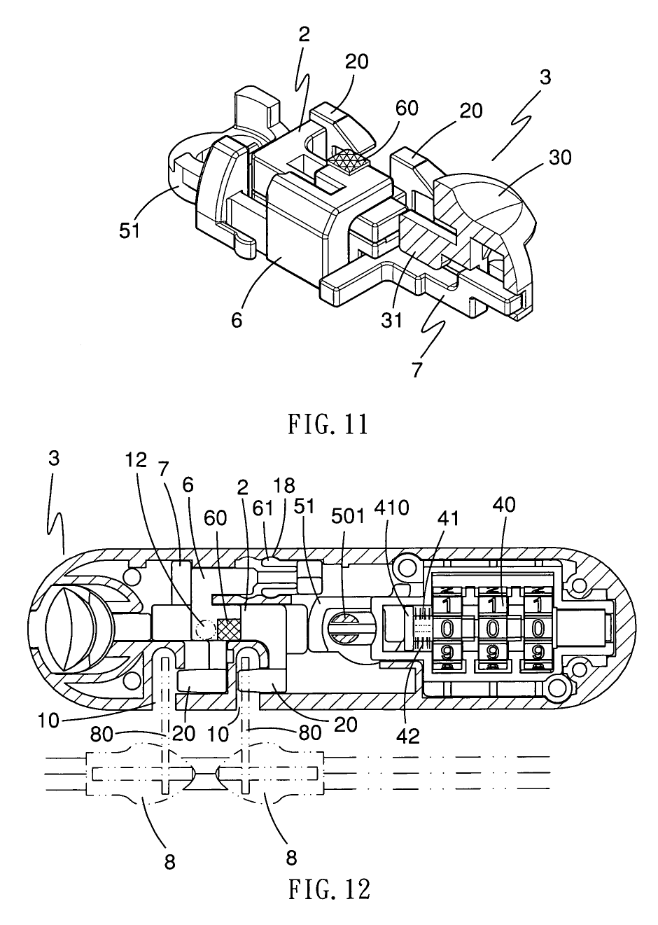

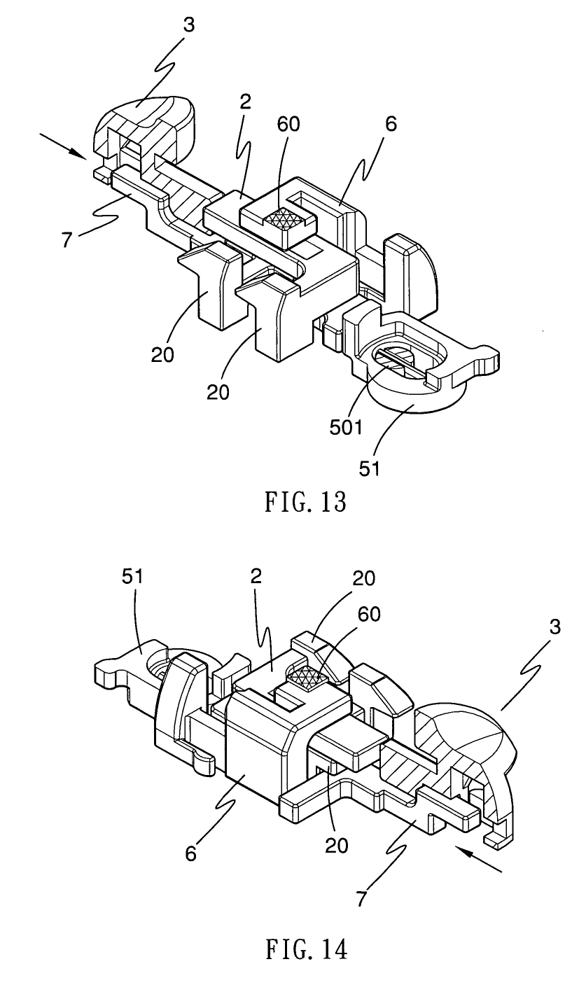

With reference to FIGS. 1 to 14, descriptions will be made of a dual locking device according to a first embodiment of this invention.

Referring now to FIG. 1, the dual locking device in accordance with the first embodiment comprises a housing 1, a switching mechanism, a restriction member 51, a first locking device 5, and a second locking device 4. Additionally, the switching mechanism includes a push-button 3 and a securing member 2.

The housing 1 has a top formed with two openings 10 communicating with the interior of the housing 1 for receiving the plugging member 80 shown in FIG. 2. Furthermore, the housing 1 also has a through hole 11, a window 12 and a plurality of number wheel slots 13, and has a side formed with a broaden cavity 14 having a channel 15, which is in communication with the interior of the housing 1. Inside the housing 1, a body 16 is served as a carrier. A base 17 is disposed at a bottom of the housing 1 for covering the same.

The securing member 2 of the switching mechanism is mounted in the housing 1 and includes two retainers 20 overlapped with each other. The two retainers 20 move together to a locking position or an unlocking position while being driven so as to block or open the openings 10 of the housing 1 respectively.

The push-button 3 in relation with the securing member 2 has a pushing portion 30 movably mounted on the broaden cavity 14, a driving portion 31 received in the channel 15 of the housing 1 and against a side of the securing member 2, and a passage 32 passing through the pushing portion 30 and the driving portion 31. Thus, the two retainers 20 of the securing member 2 can be driven to come off the openings 10 by pushing the push-button 3 from the outside of the housing 1.

The first locking device 5 and the second locking device 4 are provided for controlling the movement of the restriction member 51. In the first embodiment, a key lock and a combination lock, as examples, are respectively the first locking device 5 and the second locking device 4. It is to be noted that, any combination from two locks of key locks and combination locks can serve as the first locking device and the second locking device.

The first locking device 5, namely the key lock, has a rotor 501, a sleeve 500 fixed on the housing 1 and received the rotor 501 which has an end formed with a key hole 502 exposed the outside of the through hole 11 of the housing 1 for being operated by a configured key (not shown) and has another end formed with a rider 503.

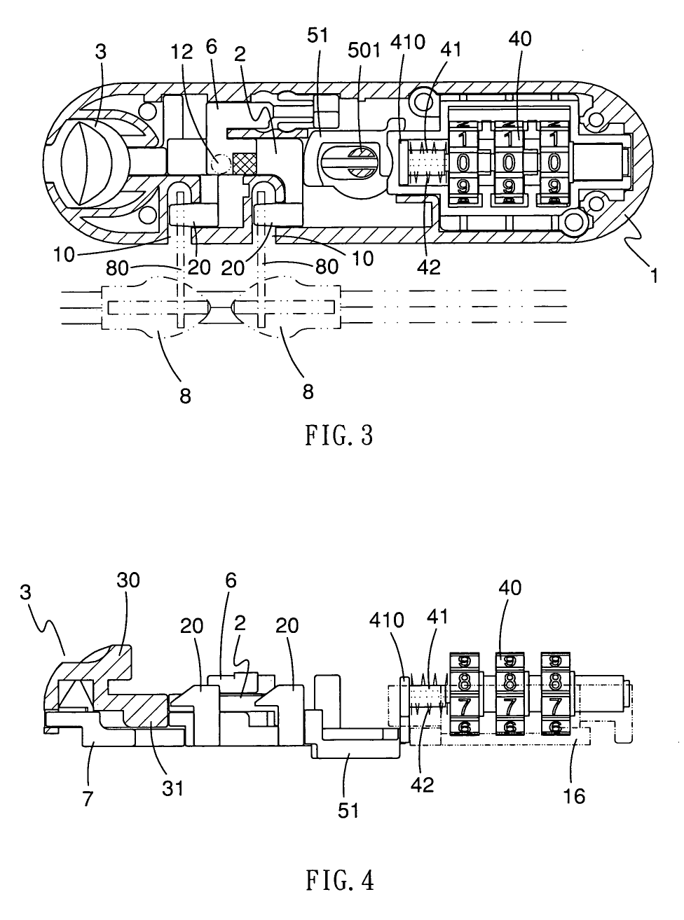

The restricting member 51 installed in the housing 1 has a cave 510 for receiving the rider 503 of the rotor 501 and a rail 511 formed in the cave 510 so that the restricting member 51 can be rotated by rotating the rotor 501 via the configured key through a first route between a retaining position and a first releasing position. In the retaining position, the restricting member 51 is confined between the securing member 2 and an underneath of a block 410 of the combination lock 4, as shown in FIG. 3, and the securing member 2 thereby is blocked in the locking position. When the restricting member 51 is rotated to the first releasing position, the securing member 2 is allowed to move to the unlocked position. Instead of rotation, the restricting member 51 can move relative to the rider 503 of the rotor 501 to a second releasing position in a result of the sliding of the rail 511 ridden by the rider 503 of the rotor 501, as described later.

The second locking device 4, namely the combination lock, is fixed in the body 16 and has a number wheel unit 40 partly exposed the outside of the number wheel slots 13, a movable shaft 41 passing through the number wheel unit 40. The shaft 41 is movable axially when a set of correct codes to the combination lock 4 are dialed and is fixed when the codes are incorrect. Furthermore, the movable shaft 41 has an end formed with the block 410 which is slidable along a specific range upon the body 16. The second locking device 4 further has a spring 42 which is around the movable shaft 41 and has one end against a side of the number wheel unit 40 and the other end against a back side of the block 410 so that a top portion of a front side of the block 410 is against a side of the body 16.

As shown in FIG. 2, the two plugging members 80 present as pull tabs of the two zippers 8 of the luggage case (not shown). Each of the plugging members has a latch hole 81 for inserting into the opening 10 so as to be locked by the retainer 20 of the securing member 2.

In FIGS. 3 and 4, each of the plugging members 80 is inserted in the opening 10 and remained in the retaining position where one end of restricting member 51 is blocked by the block 410 of the shaft 41. In this state, the latch holes 81 of the two plugging members 80 are inserted into the two openings 10 of the housing 1 as to be locked by the incorrect codes of the combination lock. When the correct codes of the combination lock are dialed and the rotor 501 of the first locking device 5 is remained without any rotation, the retainers 20 of the securing member 2 are about ready for being moved away by the push-button 3 to the second releasing position, as described as follows.

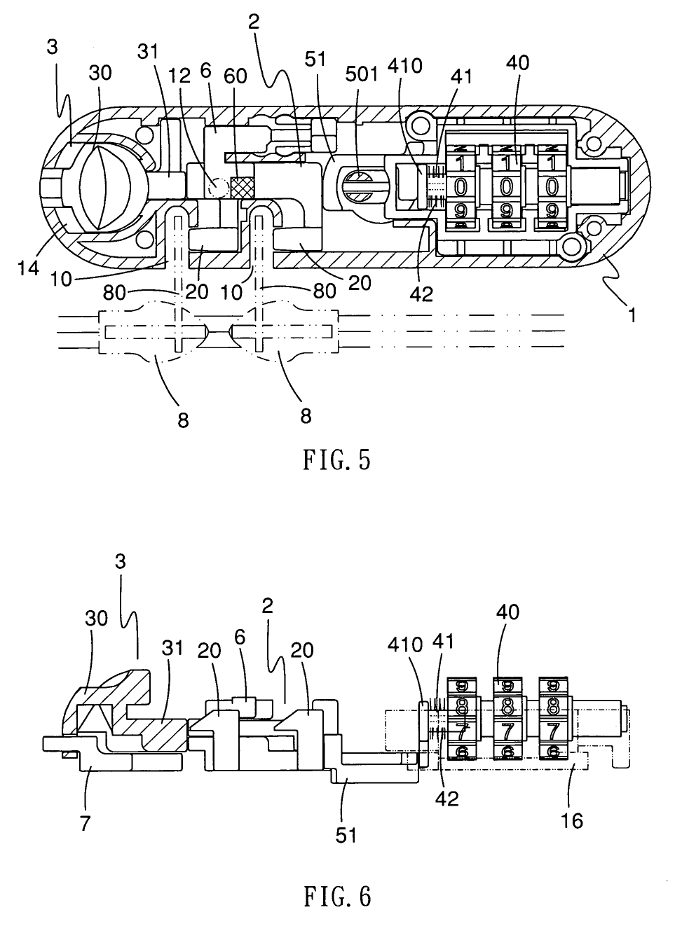

FIGS. 5 and 6 show how the second locking device 4 is used to unlock the dual locking device by controlling the movement of the restriction member 51 via a second route between the retaining position and a second releasing position. When the number wheel unit 40 is rotated and dialed to correct codes to allow the shaft 41 to move axially, the pushing portion 30 of the push-button 3 can be pushed within the broaden cavity 14 that the driving portion 31 of the push-button 3 can drive first the securing member 2 which then drives the restricting member 51 accordingly from the retaining position to the second releasing position to push the block 410. The block 410 then immediately propels the movable shaft 41 axially and presses the spring 42. At the same time, the retainers 20 of the securing member 2 have been moved to the unlocking position, off the openings 10 of the housing 1, and release the plugging members 80 from the openings 10.

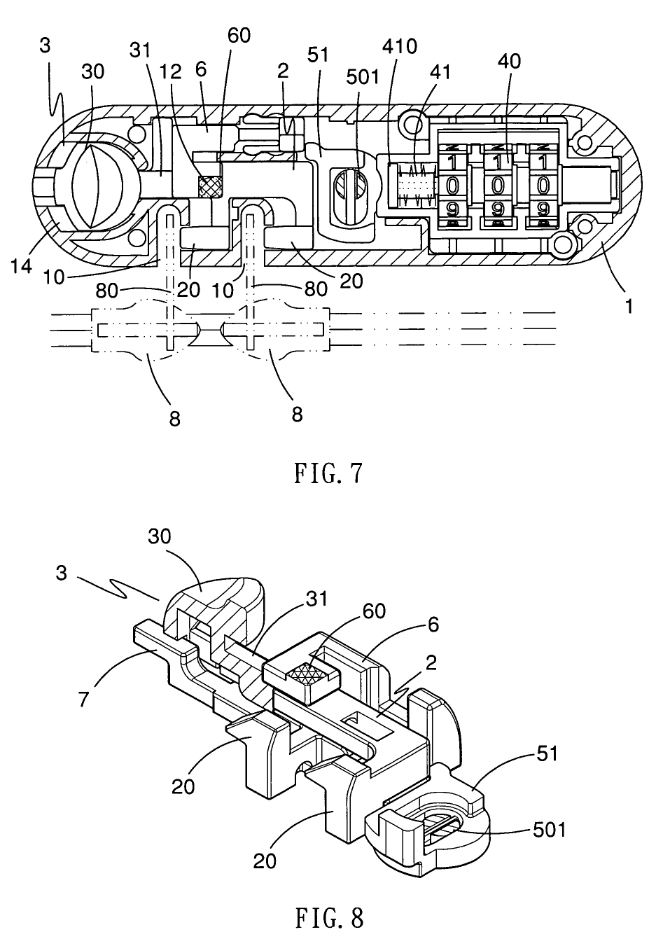

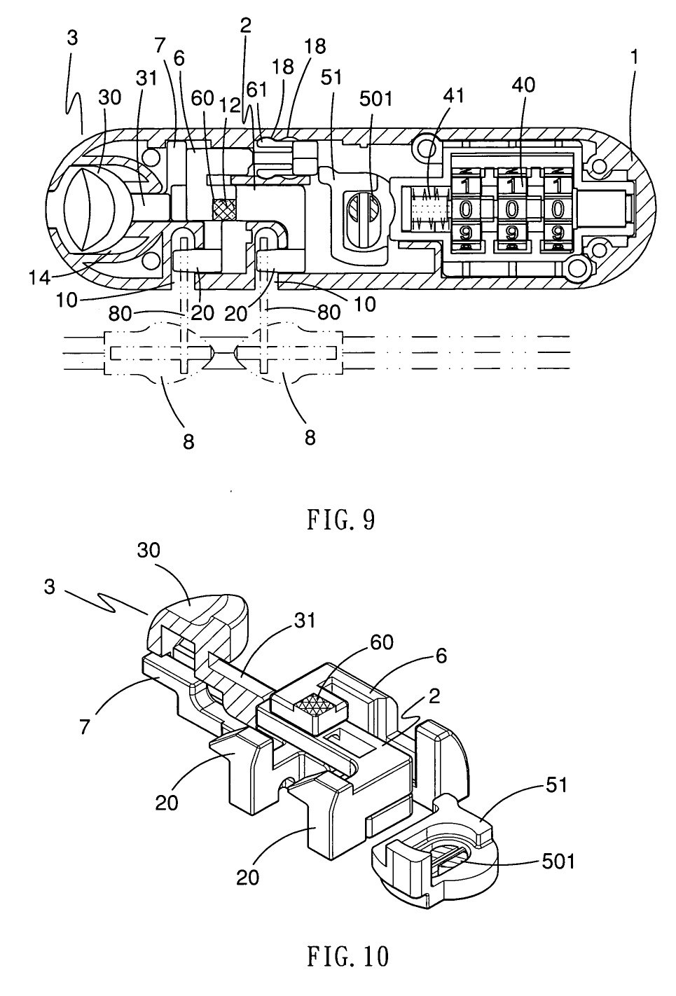

Next, FIGS. 7 to 9 describe how the first locking device 5 is used to unlock the dual locking device by controlling the movement of the restriction member 51 via the first route between the retaining position and the first releasing position. When the second locking device 4 is locked upon the incorrect codes that the shaft 41 can not move axially, the configured key (not shown) can be used to turn the rotor 501 to drive the restricting member 51 to rotate 90 degrees counterclockwise from the retaining position, as shown in FIG. 3, to the first releasing position, as shown in FIG. 9 that is recognized as the first route. In the meantime, a room next to the securing member 2 is formed in a result of the restricting member 51 not against the securing member 2 anymore so that the pushing portion 30 of the push-button 3 can be pushed accordingly and displaced within the broaden cavity 14, as shown in FIG. 7, that the driving portion 31 of the push-button 3 can drive the two retainers 20 of the securing member 2 to move to the unlocking position, off the openings 10 of the housing 1, so as to release the plugging members 80 from the openings 10. Therefore, an inspector can hold the configured key to check the luggage without damage the same via the first locking device 5.

Referring back to FIG. 1, the dual locking device according to the first embodiment may further comprise an indicator 6 installed in the housing 1 and a reposition device 7 received in the passage 32 of the push-button 3. The reposition device 7 has an end in proximity to a side of the indicator 6, which can be moved either to display an identification member 60 thereof through the window 12 of the housing 1 or to make the identification member 60 come off the window 12 for hiding the identification member 60.

In FIGS. 9 to 11, when rotating 90 degrees counterclockwise to the first releasing position, the restricting member 51 pushes an end of the indicator 6 to expose the identification member 60 from the window 12 of the housing 1 where the other end of the indicator 6 is against an end of the reposition device 7. Accordingly, an owner of the case can identify whether the case has been checked by others, such an inspector of the Customs.

FIGS. 12 to 14 show that the identification member 60 of the indicator 6 is displaced from the window 12 of the housing 1. When both the correct codes of the combination lock are dialed and the rotor 501 is rotated to drive the restricting member 51 back to the retaining position, the other end of the reposition device 7 can be pushed from the passage of the push-button 3 so that the reposition device 7 is driven first to push the nearest retainer 20 which then pushes the block 410 accordingly. Next, the block 410 continually propels the shaft 41 axially and presses the spring 42. In this time, the retainers 20 of the securing member 2 come off the opening 10 of the housing 1 to release the pull tabs 80 from the openings 10 and the indicator 6 is propelled back to a position where the identification member 60 of the indicator 6 is hidden, not being displayed through the window 12 of the housing 1.

As shown in FIGS. 9 and 12, the housing 1 can further include two positioning notches 18 and the indicator 6 can further include a protrusion 61 formed a side thereof. Thus, when the indicator 6 is moved to display or hide the identification member 60 through the window 12 of the housing 1, the protrusion 61 can be positioned in one of the two positioning notches 18.

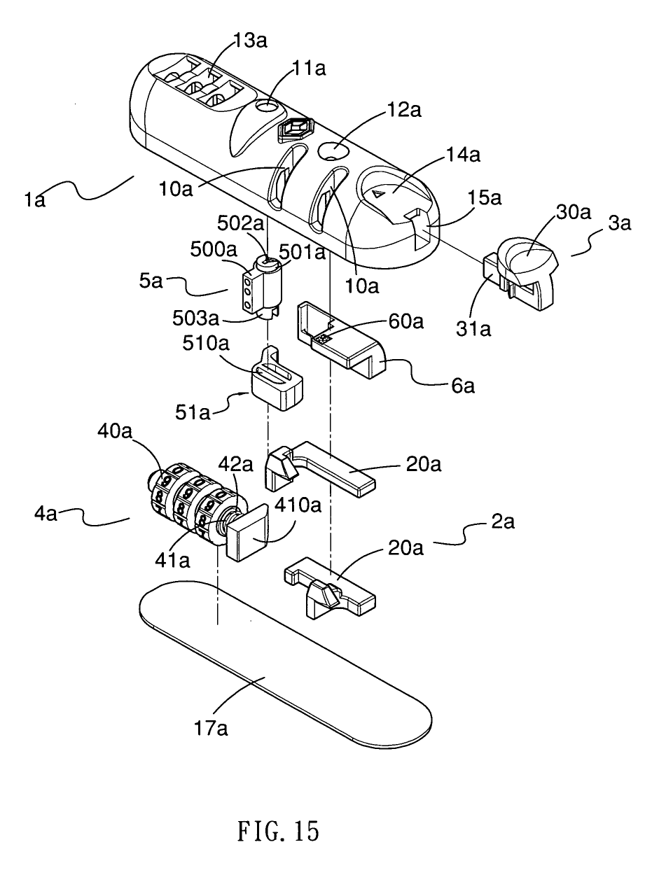

With reference to FIGS. 15 to 20, a second embodiment, which shows a dual locking device of the present invention, is described as below.

Comparing with the first embodiment, the second embodiment has no the reposition device 7. Instead, a push button 3a of the second embodiment is arranged to have a first route for driving a securing member 2a to unlock the dual locking device and a second route after the first route for pushing an indicator 6a back to an original position.

Referring now to FIG. 15, the dual locking device in accordance with the second embodiment comprises a housing 1a, a switching mechanism, a restriction member 51a, a first locking device 5a, and a second locking device 4a. Additionally, the switching mechanism includes the push-button 3a and the securing member 2a.

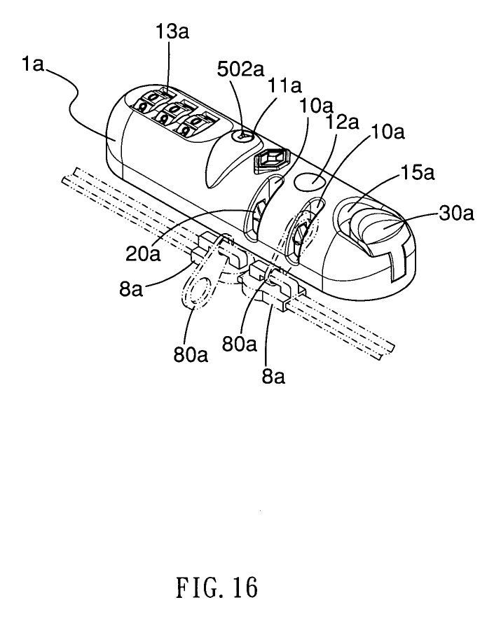

Similarly to the first embodiment, the housing 1a has a top formed with two openings 10a communicating with the interior of the housing 1a for inserting the plugging member 80a as shown in FIG. 16. The housing 1a also has a through hole 11a, a window 12a and a plurality of number wheel slots 13a, and has a side formed with a broaden cavity 14a having a channel 15a communicating with the interior of the housing 1a. A base 17a may be disposed at a bottom of the housing 1 for covering the same.

The securing member 2a of the switching mechanism is mounted in the housing 1a and includes two retainers 20a overlapped with each other. The two retainers 20a can move together to a locking position or an unlocking position while being driven so as to block or open the openings 10a of the housing 1a respectively.

The push-button 3a in relation with the securing member 2a has a pushing portion 30a movably mounted on the broaden cavity 14a, a driving portion 31a received in the channel 15a of the housing 1a and against a side of the securing member 2a. Thus, the retainers 20a of the securing member 2a can be driven to come off the openings 10a by pushing the push-button 3a from the outside of the housing 1a.

The first locking device 5a and the second locking device 4a are provided for controlling the movement of the restriction member 51a. In the second embodiment, a key lock and a combination lock, as examples, serve respectively as the first locking device 5a and the second locking device 4a.

The first locking device 5a, namely the key lock, has a rotor 501a, a sleeve 500a fixed on the housing 1a and received the rotor 501a which has an end formed with a key hole 502a exposed the outside of the through hole 11a of the housing 1a for being operated by a configured key (not shown) and has another end formed with a rider 503a.

The restricting member 51a installed in the housing 1a has a cave 510a for receiving the rider 503a of the rotor 501a and a rail 511a formed in the cave 510a so that the restricting member 51a can be rotated by rotating the rotor 501a via the configured key through the first route between a retaining position and a first releasing position. In the retaining position, the restricting member 51a is confined between the securing member 2a and a block 410a of the second locking device 4a, as shown in FIG. 16, and the securing member 2a thereby is blocked in the locking position. When the restricting member 51a is rotated to the first releasing position, the securing member 2a is allowed to move to the unlocked position. Instead of rotation, the restricting member 51a can move relative to the rider 503a of the rotor 501a to a second releasing position in a result of the sliding of the rail 511a ridden by the rider 503a of the rotor 501a.

The second locking device 4a, namely the combination lock, is mounted in the housing 1a and has a number wheel unit 40a partly exposed the outside of the number wheel slot 13a, a movable shaft 41a passing through the number wheel unit 40a. The shaft 41a is movable axially when a set of correct codes to the second locking device 4a are dialed and is fixed when the codes are incorrect. Furthermore, the movable shaft 41a has an end formed with the block 410a which is slidable along a specific range. The second locking device 4a further has a spring 42a which is around the movable shaft 41a and has one end against a side of the number wheel unit 40a and the other end against a back side of the block 410a.

As shown in FIG. 16, the plugging members 80a present as pull tabs of the two zippers 8a of the luggage case (not shown). Each of the plugging members 80a has a latch hole 81a for inserting into the opening 10a so as to be locked by the retainers 20a of the securing member 2a.

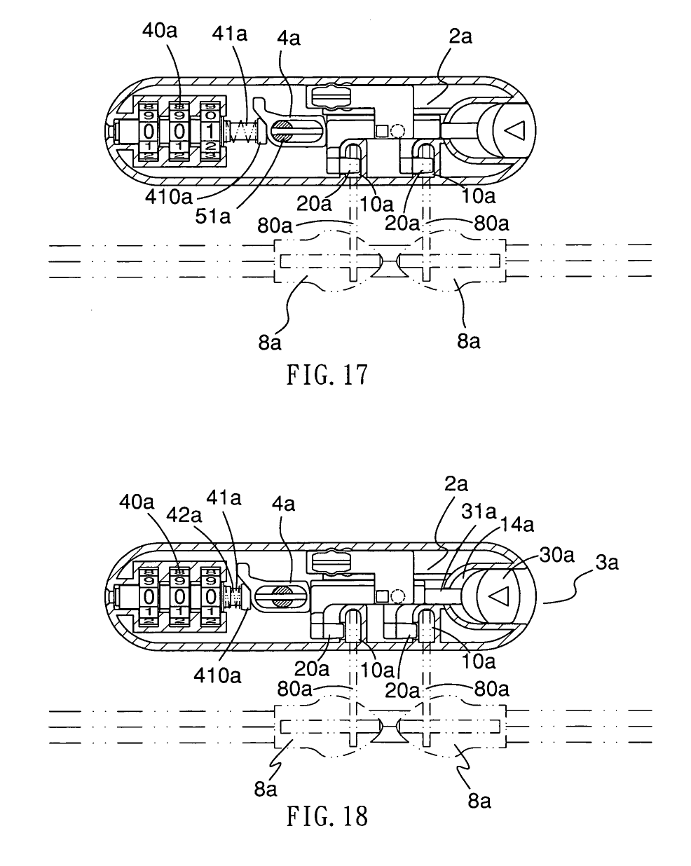

Referring now to FIG. 17, each of the plugging members 80a is inserted into the opening 10a. When the second locking device 4a is locked and the rotor 501a of the key lock 5a can not been rotated, the restricting member 4a remains in the retaining position where one end of the restricting member 4a is blocked by the block 410a of the movable shaft 41a so that the two retainers 20a of the securing member 2a can not be moved by pushing the push-button 3a. In the meantime, the two latch holes 81a of the plugging members 80a can be inserted into the two openings 10a of the housing 1a so as to be locked.

FIG. 18 shows how the second locking device 4a is used to unlock the dual locking device by controlling the movement of the restriction member 51a via the second route between the retaining position and a second releasing position. When the number wheel unit 40a is rotated and the correct codes are dialed to allow the shaft 41a to move axially, the pushing portion 30a of the push-button 3a can be pushed within the broaden cavity 14a that the driving portion 31a of the push-button 3 can drive the securing member 2a which then drives the restricting member 51 from the retaining position to the second releasing position to push the block 410a. The block 410a then immediately propels movable shaft 41a axially and presses the spring 42a. At the same time, the retainers 20a of the securing member 2a have been moved to the unlocking position, off the openings 10a of the housing 1a, and released the plugging members 80a from the openings 10a.

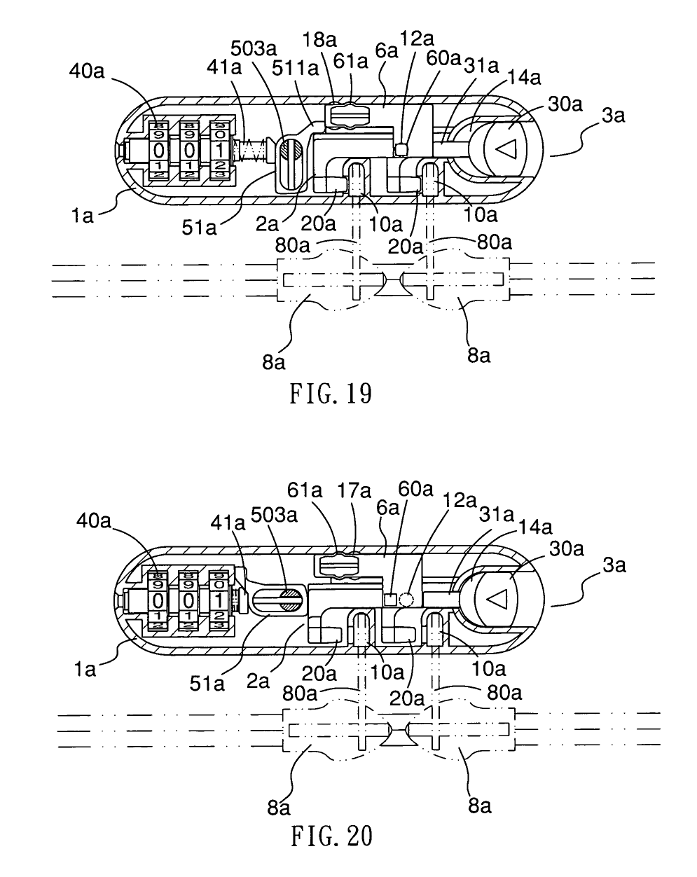

Next, FIG. 19 shows how the first locking device 5a is used to unlock the dual locking device by controlling the movement of the restriction member 51a via the first route between the retaining position and the first releasing position. When the combination lock 4a is locked that the shaft 41a can not move axially, the configured key (not shown) can be turned to rotate the rotor 501a so as to drive the restricting member 51a to rotate 90 degrees counterclockwise from the retaining position to the first releasing position that is recognized as the first route. In the meantime, a room next to the securing member 2a is formed in a result of the restricting member 51a not against the securing member 2a anymore so that the pushing portion 30a of the push-button 3a can be pushed and displaced within the broaden cavity 14a that the driving portion 31a of the push-button 3a can drive the retainers 20a of the securing member 2a to move to the unlocking position, off the openings 10a of the housing 1a, so as to release the plugging members 80a from the openings 10a, similarly to the first embodiment.

In FIG. 15, the dual locking device according to the second embodiment can also comprise the indicator 6a installed in the housing. The indicator 6a can be moved either to display an identification member 60a through the window 12a of the housing 1a or to make the identification member 60a come off the window 12a for being hidden.

Referring to FIG. 19, when rotating the restricting member 51a to 90 degrees clockwise to the first releasing position, a rod 511a extended from the restricting member 51a is turned to push an end of the indicator 6a to expose the identification member 60a from the window 12a of the housing 1a. Accordingly, an owner of a case with the dual locking device may identify whether the case was checked by others, such an inspector of the Customs.

In FIG. 20, the identification member 60a of the indicator 6a is displaced in the window 12a of the housing 1a. When the correct codes of the combination lock are dialed and the rotor 501a is rotated to drive the restricting member 51a back to the retaining position, and by pushing the push-button 3a, the driving portion 31a of the push-button 3a can first be pushed to drive the retainers 20a of the securing member 2a to come off the opening 10a of the housing 1a so as to release the plugging members 80a. The driving portion 31a can further be pushed to propel the indicator 6a back to the original position where the identification member 60a of the indicator 6a is hidden, not being displayed through the window 12a of the housing 1a.

As shown in FIGS. 17 to 20, the housing 1a can further include two positioning notches 18a and the indicator 6a can further include a protrusion 61a. Thus, when the indicator 6a is displaced to display or hide the identification member 60a from the window 12a of the housing 1a, the protrusion 61a can be positioned in one of the two positioning notches 18a.

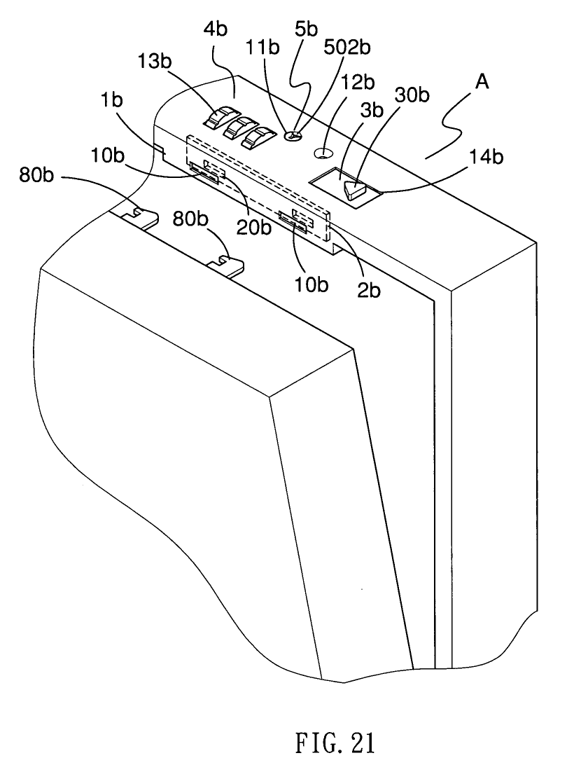

FIGS. 21 to 27 show a dual locking device as a third embodiment of the present invention and the structures of the third embodiment are similar to the above embodiments.

Referring now to FIGS. 21 to 23, the dual locking device according to the third embodiment comprises a housing 1b, a switching mechanism, a restriction member 51b, a first locking device 5b, and a second locking device 4b. Additionally, the switching mechanism includes a push-button 3b and a securing member 2b.

The housing 1b has a side formed with two openings 10b communicating with the interior of the housing 1b for receiving a plugging member 80b. The housing 1b has a top formed with a through hole 11b, a window 12b and a plurality of number wheel slots 13b, and has another side formed with a broaden cavity 14b having a channel (not shown) communicating with the interior of the housing 1b.

The securing member 2b of the switching mechanism is mounted in the housing 1b and includes two retainer openings 20b, (instead of the retainers 20 or 20a of the above embodiments), formed in the securing member 2b. The retaining openings 20b along with the securing member 2b can move to a locking position or an unlocking position so as to block or open the openings 10b of the housing 1b respectively.

The push-button 3b in relation with the securing member 2b has a pushing portion 30b movably mounted on the broaden cavity 14b, a driving portion 31b received in the channel of the housing 1b and connected with a side of the securing member 2b. Thus, the retaining openings 20b of the securing member 2b can be driven to come off the openings 10b by pushing the push-button 3b from the outside of the housing 1b.

The first locking device 5b and the second locking device 4b are provided for controlling the movement of the restriction member 51b. In this third embodiment, a key lock and a combination lock, as examples, serve respectively as the first locking device 5b and the second locking device 4b.

The first locking device 5b, namely the key lock, has a rotor 501b, a sleeve 500b fixed on the housing 1b and received the rotor 501b which has an end formed with a key hole 502b exposed the outside of the through hole 11b of the housing 1b for being operated by a configured key (not shown) and has another end formed with a rider 503b in a square shape.

The restricting member 51b installed in the housing 1b has a cave 510b in rectangle shape for mating with the rider 503b of the rotor 501b so that the restricting member 51b can be rotated by rotating the rotor 501b via the configured key through a first route between a retaining position and a first releasing position. In the retaining position, the restricting member 51b is confined between the push-button 3b and a block 410b of the second locking device 4b, as shown in FIG. 23, and the push-button 3b thereby can not move to drive the securing member 2b that the retaining openings 20b of the securing member 2b remain in the locking position. When the restricting member 51b is rotated to the first releasing position, the push-button 3b thereby is allowed to be pushed to drive the retaining openings 20b to an unlocking position. Instead of rotation, the cave 510b of the restricting member 51b is in rectangle shape that the restricting member 51b can slide in relative to the rider 503b of the rotor 501b to a second releasing position, as shown in FIG. 25.

The second locking device 4b, namely the combination lock 4b, is mounted in the housing 1b and has a number wheel unit 40b partly exposed the outside of the number wheel slot 13b, and the block 410b is next to the number wheel unit 40b. The block 410b is movable vertically when a set of correct codes to the combination lock are dialed and is fixed when the incorrect codes are dialed. When the combination lock is unlocked and the block 410b is accordingly displaced to an upper position, the restriction member 51b is allowed to move toward the second locking device 4b, and a room is formed for the movement of the push-button 3b, as shown in FIG. 25. Reversely, when the combination lock is locked and the block 410b is displaced to a lower position, the restriction member 51b is blocked, no room exists for the movement of the push-button 3b, as shown in FIG. 23.

As shown in FIG. 21, two plugging members 80b present as hooks of a luggage case. Each of the plugging members 80b can be inserted into the opening 10b to be locked by the retaining openings 20b of the securing member 2b.

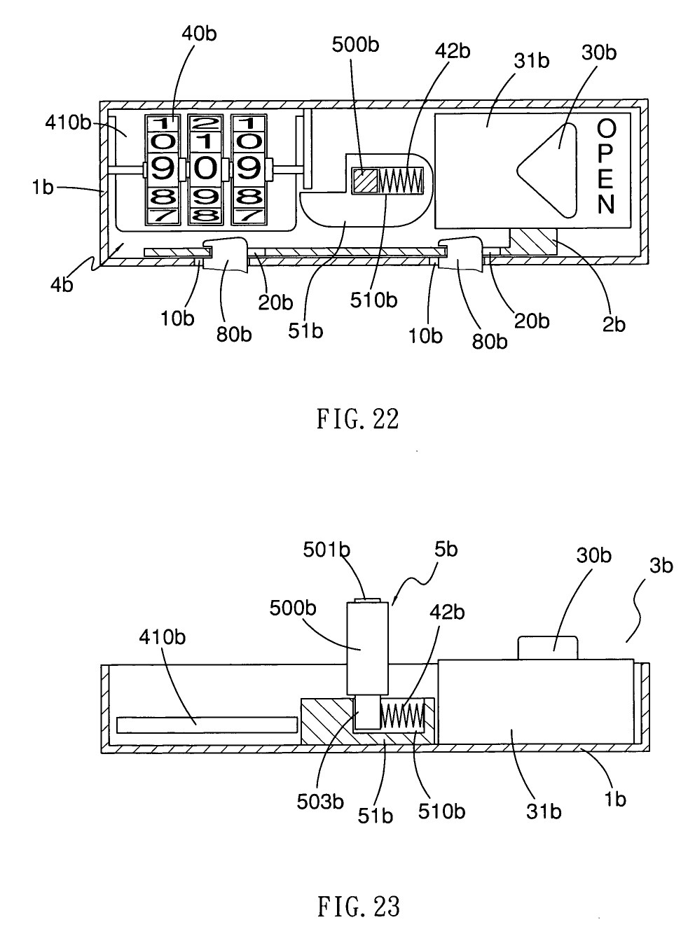

In FIGS. 22 and 23, each of the plugging members 80b is inserted into the opening 10b. When the correct codes of the second locking device 4b are not dialed and the rotor 501b of the key lock 5b has not been rotated, the restricting member 4b remains in the retaining position where one end of the restriction is blocked by the block 410b of the second locking device 4b so that the two retaining holes 20b of the securing member 2b can not be moved by pushing the push-button 3b. In the meantime, the plugging members 80b are locked by the retaining openings 20b of the securing member 2b.

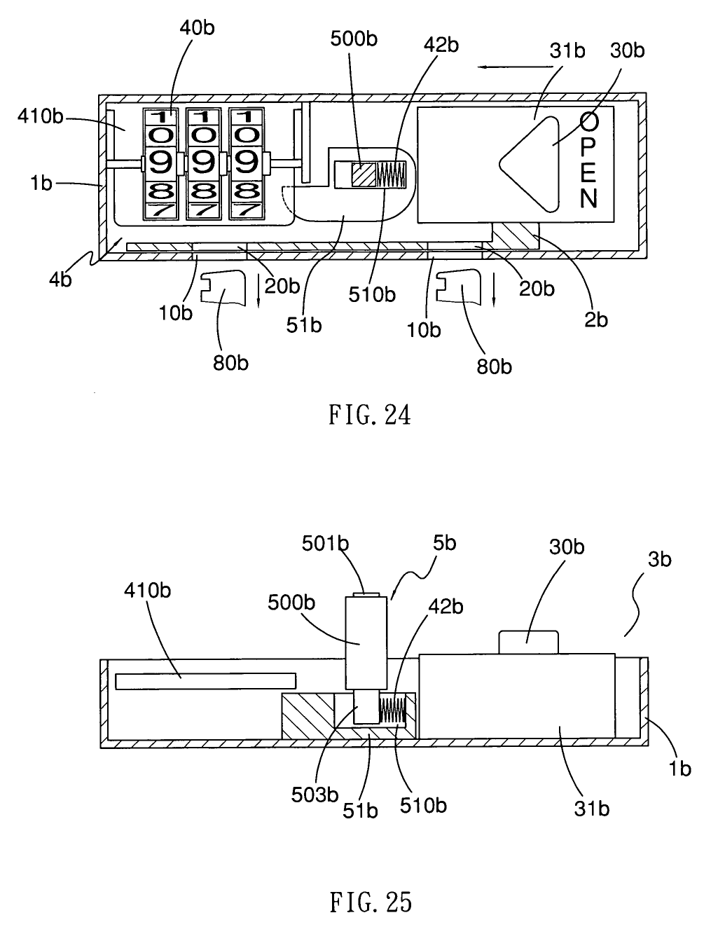

FIGS. 24 and 25 show the second locking device 4b is used to unlock the dual locking device by controlling the movement of the restriction member 51b via a second route between the retaining position and a second releasing position. When the number wheel unit 40b is rotated to the correct codes to displace vertically the block 410b to the upper position, the pushing portion 30b of the push-button 3b can be pushed within the broaden cavity 14b that the driving portion 31b of the push-button 3b can drive the securing member 2b and then drives the restricting member 51b from the retaining position to the second releasing position to have the restricting member 51b under the block 410b. At this time, by pushing the push-button 3b, the retaining openings 20b of the securing member 2b have been moved accordingly to the unlocking position, off the openings 10b of the housing 1b, and to release the plugging members 80b.

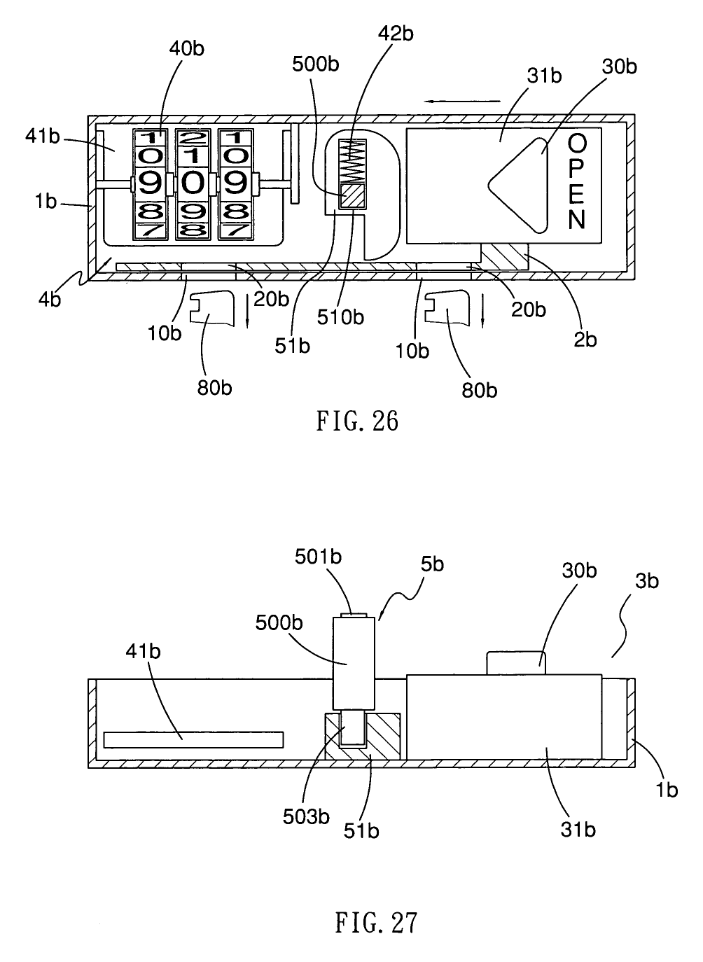

FIGS. 26 and 27 show how the first locking device 5b is used to unlock the dual locking device by controlling the movement of the restriction member 51b via the first route between the retaining position and the first releasing position. When the correct codes of the combination lock 4b are not dialed that causes the block 410b can not move vertically, the configured key (not shown) is used to turn the rotor 501b to drive the restricting member 51b to rotate 90 degrees from the retaining position to the first releasing position, as recognized as the first route. In the meantime, the pushing portion 30b of the push-button 3b can be pushed and displaced within the broaden cavity 14b that causes the driving portion 31b of the push-button 3b can drive the retaining openings 20b of the securing member 2b to move to the unlocking position, off the openings 10b of the housing 1b, so as to release the plugging members 80b from the openings 10b.

Moreover, the dual locking device in the third embodiment can further comprises an indicator (not shown) installed in the housing and exposed an identification member (not shown) from the window 12 of the housing as illustrated in the above embodiments.

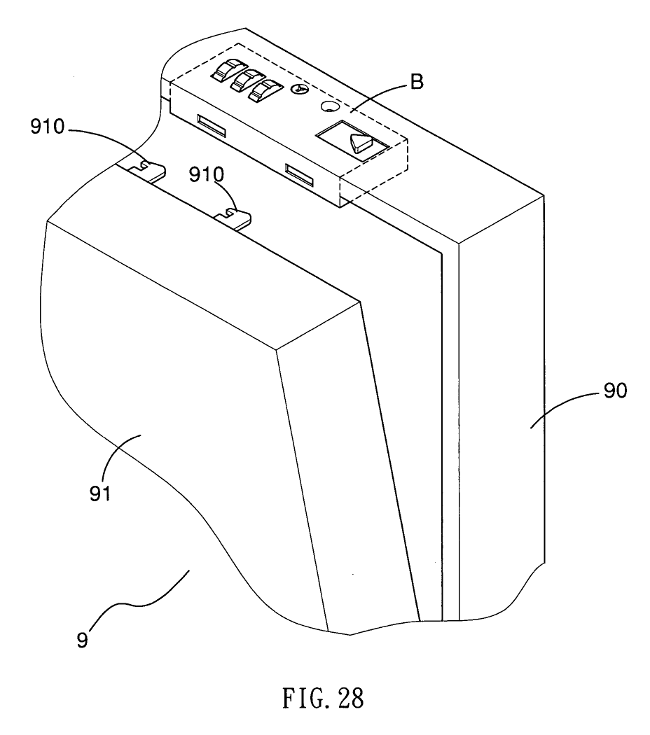

Additionally, as shown in FIG. 28, the dual locking device of the present invention can be further applied to a case 9 which comprises a case body 90, a case cover 91 and the dual locking device B, which is any dual locking device described above. Furthermore, a side of the case body 90 is jointed with a side of the case cover 91, and the plugging members 910 are mounted on the case cover 91 for being secured in the dual locking device B which is mounted on the case body 90.

Numerous characteristics and advantages of the invention have been set forth in the foregoing description, together with details of the structure and function of the invention, and the novel features thereof are pointed out in appended claims. The disclosure, however, is illustrative only, and changes may be made in detail, especially, in matters of shape, size and arrangement of parts, materials and the combination thereof within the principle of the invention, to the full extent indicated by the broad general meaning of the terms in which the appended claims are expressed.

We claim:

1. A dual locking device comprising:
a housing, having at least one opening communicating with the interior of the housing for receiving a plugging member;
a switching mechanism, having a push-button and a securing member movable relative to the housing between a locked position and an unlocked position by pushing the push-button which drives the securing member and is partly exposed the outside of the housing;
a restriction member, being capable of moving through a first route between a retaining position to a first releasing position and through a second route between the retaining position to a second releasing position; wherein the restriction member limits the movement of the switching mechanism while in the retaining position, and permits the switching mechanism to move to the unlocked position while in the first or second releasing positions;
a first locking device, provided for controlling the movement of the restriction member via the first route; and
a second locking device, provided for controlling the movement of the restriction member via the second route.

2. The dual locking device of claim 1, wherein the first locking device is mounted on the restriction member.

3. The dual locking device of claim 2, further comprising an indicator having an identification member directly driven by the restriction member when the dual locking device is unlocked by the first locking device.

4. The dual locking device of claim 3, wherein the restriction member is formed with a rod provided for pushing the indicator in response to the movement of the restriction member so that the identification member is displayed through a window of the housing.

5. The dual locking device of claim 4, further comprising a reposition device that can drive the indicator to make the identification member off the window of the housing.

6. The dual locking device of claim 4, wherein the push-button is formed with a driving portion that can push the indicator to make the identification member off the window of the housing by pushing the push-button after the dual locking device is unlocked by the second locking device.

7. The dual locking device of claim 2, wherein the first locking device is a key lock having a rotor driven by a configured key, and the rotor is received and slidable within a cave of the restriction member for driving the restriction member to rotate.

8. The dual locking device of claim 7, wherein the restriction member has a rail formed in the cave of the restriction member for being ridden by a rider of the rotor.

9. The dual locking device of claim 1, wherein the securing member of the switching mechanism includes two retainers overlapped with each other and against a side of the push-button.

10. The dual locking device of claim 3, wherein the securing member of the switching mechanism includes two retainers overlapped with each other, and the indicator overlies the two retainers of the securing member of the switching mechanism.

11. A case comprising a case body, a case cover and a dual locking device, wherein a side of the case body is jointed with a side of the case cover, and a plugging member is mounted on the case cover for being secured in the dual locking device which is mounted on the case body, and the dual locking device comprises:
a housing, having at least one opening communicating with the interior of the housing for receiving the plugging member;
a switching mechanism, having a push-button and a securing member movable relative to the housing between a locked position and an unlocked position by pushing the push-button which drives the securing member and is partly exposed the outside of the housing;
a restriction member, being capable of moving through a first route between a retaining position to a first releasing position and through a second route between the retaining position to a second releasing position; wherein the restriction member limits the movement of the switching mechanism while in the retaining position, and permits the switching mechanism to move to the unlocked position while in the first or second releasing positions;
a first locking device, provided for controlling the movement of the restriction member via the first route; and
a second locking device, provided for controlling the movement of the restriction member via the second route.

12. The case of claim 11, wherein the locking device further comprises an indicator which can shift from one state to another state when the dual locking device is unlocked by the first locking device.
